(19) United States
(12) Patent Application Publication
(10) Pub. No.: US 2010/0082844 A1
(43) Pub. Date: Apr. 1, 2010

(54) FIELD DEVICE CONTROLLER ADAPTER

(75) Inventors: James Stoupis, Durham, NC (US); Mohamed Y. Haj-Maharsi, Garner, NC (US)

Correspondence Address: Driggs, Hogg, Daugherty & Del Zoppo Co., L.P.A., 38500 CHARDON ROAD, DEPT. ABB, WILLOUGHBY HILLS, OH, 44094, US

(73) Assignee: ABB Research Ltd., Zurich (CH)

(21) Appl. No.: 12/241,618

(22) Filed: Sep. 30, 2008

(51) Int. Cl. G06F 3/00

(52) U.S. Cl. 710/11

(57) ABSTRACT

A controller adapter including a controller interface configured to interface with a controller for a legacy field device of an electrical power distribution system, wherein the controller communicates based on a first protocol, a network interface configured to interface with a network common to a plurality of assets of the electrical power distribution system, wherein the network interface communicates based on a second protocol, a mapper that maps information received from the legacy field device controller about the legacy device that to the second protocol, and storage that stores at least one logic function, wherein at least one input and/or output of the logic function is connected to the mapped information.

### BACKGROUND

The following generally relates to assets used in an electrical power generation, transmission and distribution system, and, more particularly, to Intelligent Electronic Devices (IEDs). It is also amenable to other microprocessor-based assets used in electrical power distribution.

The electric utility industry operates under an asset intensive, continuous production business model. Indeed, the generation, transmission and distribution of electricity typically requires a great deal of relatively high value, specialized equipment. While this equipment can be expensive to purchase and maintain, its continued, reliable operation is vital to the uninterrupted supply of energy to home, industrial, commercial and other consumers of electrical power.

Substations and feeder equipment, which are an important components of the electrical power distribution system, typically contain or are otherwise dependent upon a number of critical assets. These assets include items such as IEDs, transformers, circuit breakers, substation batteries and battery chargers, capacitor banks, and underground cables, to name but a few. Optimizing the maintenance, repair, and replacement of these and other assets can be a challenging task, particularly when viewed in the larger context of system reliability.

One trend has been the use of microprocessor-based data gathering, control and protective relays which are commonly referred to as intelligent electronic devices (IEDs). IEDs allow configurable protection of assets, gather and process detailed load and/or specific asset data, and provide the ability to control the state of the power system over communication channels using a variety of protocols, such as IEC61850, which is one of several standards for substation automation systems. It is thought that IEC61850 will be the de facto automation standard in the industry in the future.

IEDs are commonly used to protect the assets from situations beyond the design limits of the asset that may lead to damage of the asset due to a fault. In addition, they can be used to control power system equipment such as to locally or remotely trip or close reclosers, switches, circuit breakers and/or tie switches, change tap positions on tap changers, operate capacitor banks, and the like. IEDs also can provide outputs indicative of the status of the IED and its associated equipment.

Unfortunately, some power distribution systems include legacy assets such as reclosers, switches, tie switches, etc. controllers that are not IEC61850 enabled, or not enable for IEC61850-based network applications. Such legacy assets have existing intelligence for standard protection and control functions and can serially communicate (e.g., via RS-232) to a modem or radio, back to a master supervisory control and data acquisition (SCADA) control center via Modbus, DNP (Distributed Network Protocol), IEC60870-5, a proprietary protocol and/or other legacy protocols.

Such legacy assets can be replaced with IEC61850-enabled assets; however, this may not be cost-effective or desired. Consequently, there remains room for improvement. More specifically, it may be desirable to use existing non-IEC61850-enabled assets more effectively.

### SUMMARY

Aspects of the present application address these matters, and others.

According to one aspect, a controller adapter includes a controller interface configured to interface with a controller for a legacy field device of an electrical power distribution system, wherein the controller communicates based on a first protocol, a network interface configured to interface with a network common to a plurality of assets of the electrical power distribution system, wherein the network interface communicates based on a second protocol, a mapper that maps information received from the legacy field device controller about the legacy device that to the second protocol, and storage that stores at least one logic function, wherein at least one input and/or output of the logic function is connected to the mapped information.

According to another aspect, a controller adapter configuration tool includes a mapper that generates a mapping that maps information from a legacy field device controller to an IEC61850-based network and a downloader that downloads the mapping to an adapter coupled to the legacy field device controller, wherein the legacy field device controller employs the mapping to map information from the legacy device controller to the IEC61850-based network.

According to another aspect, a system includes an adapter and a controller adapter configuration tool. The adapter includes a controller interface configured to interface with a controller for legacy field device of an electrical power distribution system, wherein the controller communicates based on a first protocol, a network interface configured to interface with a network common to a plurality of assets of the electrical power distribution system, wherein the network interface communicates based on an IEC61850 protocol, a first mapper that maps information received from the legacy field device controller about the legacy device that to the IEC61850 protocol, and storage that stores at least one logic function, wherein at least one input and/or output of the logic function is connected to the mapped information. The controller adapter configuration tool includes a second mapper that generates a mapping that maps information from a legacy field device controller to the IEC61850-based protocol and a downloader that downloads the mapping to an adapter coupled to the legacy field device controller, wherein the legacy field device controller employs the mapping to map information from the legacy device controller to the IEC61850-based network.

According to another aspect, a method include generating a mapping, via an adapter configuration tool, that maps information from a legacy field device controller to an IEC61850-based protocol and downloading the mapping to the adapter, wherein the legacy field device controller employs the mapping to map information from the legacy device controller to the IEC61850-based network.

According to another aspect, a method includes employing a mapping, generated by an adapter configuration tool, to map information from a legacy field device controller to an IEC61850-based protocol and to map information formatted in the IEC61850-based protocol to a protocol of the legacy field device controller, wherein the protocol of the legacy field device is different then the IEC61850-based protocol.

Those skilled in the art will appreciate still other aspects of the present application upon reading and understanding the attached figures and description.

### FIGURES

The present application is illustrated by way of example and not limitation in the figures of the accompanying drawings, in which like references indicate similar elements and in which:

FIG. 1 illustrates an example electrical power system;

FIG. 2 illustrates communication between a legacy controller and an adapter;

FIG. 3 illustrates an example adapter configuration tool;

FIG. 4 illustrates a first method;

FIG. 5 illustrates a second method; and

FIG. 6 illustrates a third method.

### DESCRIPTION

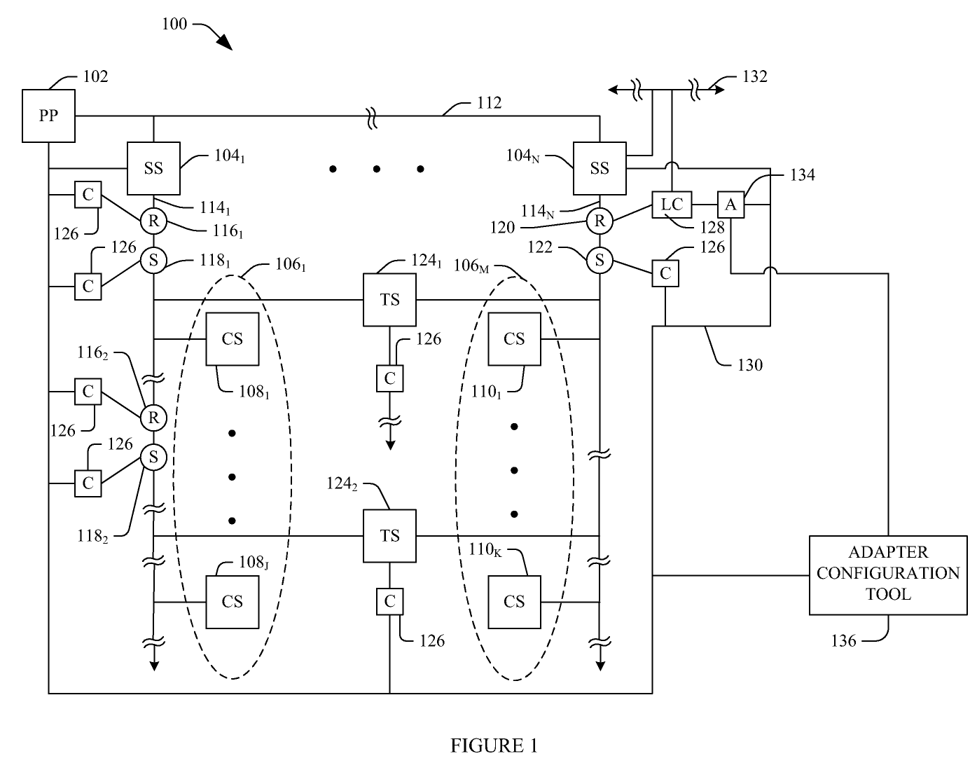

FIG. 1 illustrates an example power generation, transmission and distribution environment 100. The environment 100 includes a power plant (PP) 102 and substations (SS) 104₁, . . . , 104_{N}, collectively referred to herein as substations 104. The substations 104 distribute power to consumers, including residential, commercial, agricultural and/or industrial consumers, in corresponding population centers 106₁ and 106_{M}, collectively referred to herein as population centers 106. The population center 106₁ includes consumers (CS) 108₁, . . . , 108_{J} (collectively referred to herein as consumers 108), and the population center 106_{N} includes consumers 110₁, . . . 110_{K} (collectively referred to herein as consumers 110). Other example environments may include more or less of the power plant 102, the substations 104, the consumers 108 and 110, and the population centers 106.

The power plant 102 generates electrical power for use by the consumers 108, 110. The illustrated power plant 102 includes a generator such as an electromechanical generator with a rotating machine that converts mechanical energy into electrical energy via relative motion between a magnetic field and a conductor. Depending on the type of generator, various energy sources can be used to turn the rotating machine such a coal, petroleum, steam, nuclear, water, solar, wind, geothermal, etc. The power plant 102 provides electrical power to the substations 104 via a transmission path 112 such as one or more transmission lines, a transmission grid, and/or other transmission path. Depending on the relative location of the power plant 102 to the substations 104, the electrical power may be transmitted over relatively short and/or relatively long transmission lines.

The transmission path 112 may include various field devices such as circuit breakers, switches, transformers, electrical state monitors, and/or other components. A transformer at the power plant 102 or in the transmission path 112 may be used to step up the generated electrical power to a suitable voltage, such as high voltage, for transmission. For example, the electrical power may be stepped up from about the 2200 Volts (V) generated by the power plant 102 to about 110 kilo-Volt (kV) or above for transmission. Higher voltages may facilitate transmission over relatively long transmission paths. Lower voltages may alternatively be transmitted. The transmission lines may include overhead and/or underground power transmission lines. The substations 104 distribute power to the consumers 108 and 110 in the population centers 106.

A substation (e.g., substation 104₁) may reroute received electrical power to another substation (e.g., substation 104_{N}). When re-routing electrical power, the substation 104₁ may boost the electrical power, via a transformer or the like, which again may allow the electrical power to travel greater distances from the power plant 102. Alternatively, the substation 104₁ decreases or steps down the high voltage for local, lower voltage distribution to the consumers 108. The substations 104 respectively distribute power via distribution paths 114₁ and 114_{N}, collectively referred to herein as distribution paths 114. The distribution paths 114 may include distribution lines including wires, cables or the like, that extend overhead via utility poles and/or underground. The distribution paths 114 also include field devices such as reclosers, circuit breakers, switches, tie switches, transformers, electrical state monitors, digital fault recorders, capacitor banks and/or other components.

The illustrated distribution path 114₁ includes reclosers (R) 116₁, 116₂ (collectively referred to herein as reclosers 116), and switches (S) 118₁, 118₂ (collectively referred to herein as switches 118), and the illustrated distribution path 114_{N} includes a recloser 120 and a switch 122. The reclosers 116, 120 include a circuit breaking mechanism and a controller 126 that can automatically close the breaker after it has been opened or tripped, for example, due to a fault or otherwise. As such, the reclosers 116, 120 can reset after a transient fault that would otherwise open a breaker or blow a fuse, and disable the distribution path 114 until a technician or the like closes the circuit breaker or replaces the blown fuse. One or more of the reclosers 116, 120 may be programmed to make several reclosing attempts when the corresponding distribution path 114 is disrupted. If the fault clears, the circuit breaking mechanism will remain closed, and normal operation of the power distribution path 114 will resume. However, if the fault is not transient, for example, due to downed wires or the like, the recloser 116, 120 will exhaust its reclosing attempts and remain tripped until manually closed.

The switches 118, 122 may be used to sectionalize or isolate sub-portions of the distribution paths 114. By way of example, assume it is desired to remove power from the consumer 108_{J}, but supply power to the consumer 108₁. This may occur during maintenance, a planned brown out, a fault upstream from the switch 118₁, etc. In this instance, the switch 118₁ can be opened, thereby isolating the sub-portion of the population center 106₁ after the switch 118₁, including the consumer 108_{J}. When the switch 118₁ is opened, the consumer 108_{J} may see a complete power outage until the switch 118₁ is closed or power from another substation distributes power to the consumer 108_{J}.

The illustrated distribution paths 114 are interconnected via tie switches (TS) 124₁ and 124₁, collectively referred to herein as tie switches 124. The tie switches 124 typically are normally open, and can be closed and subsequently re-opened. Operation of the tie switches 124 may be by remote control from a control center, a lineman, and/or a control device. This allows for selective removal and/or supply of electrical power from the substations 104. By way of example, if the substation 104₁ is able to distribute power to the consumers 108, then the tie switches 124 remain or transition to an open state. However, if the substation 104₁ becomes unable to distribute power to the consumers 108 and the substation 104_{N} can handle the additional load, the tie switch 124₁ may be opened so that the substation 104_{N} distributes power to the consumers 108, along with distributing power to the consumer 110. In another instance, if power from substation 114₁ is unable to reach the consumer 108_{J}, the tie switch 124₂ can be closed, and power from the substation 104_{N} distributes power to the consumer 108_{J}. The tie switches 124 can be opened once the substation 114₁ is able to distribute power to the consumers 108.

In the illustrated example, the reclosers 116, the switches 118, 122 and the tie switches 124 are controlled by controllers (C) 126, and the recloser 120 is controlled by a legacy controller (LC) 128. The controllers 126, 128 generally are microprocessor-based controller such as Intelligent Electronic Devices (IEDs) or the like. A typical IED includes a microprocessor and memory for storing data and various microprocessor executable instructions. Examples of such instructions include, but are not limited to, instructions for one or more protection functions, one or more control functions, and/or other functions. Controllers may also be used with other assets of the system 100 such as transformers, capacitor banks, monitors, circuit breakers, power quality measurement devices, digital fault recorders, etc. The controllers 126, 128 receive data from their corresponding field device such as voltage, current, and/or power values, and/or other data, and can issue control commands to their respective field device. In the illustrated example, this includes providing control signals that open and/or close a corresponding recloser, switch or tie switch.

In the illustrated example, the controllers 126 are IEC61850-enabled, or support the IEC61850 standard for substation automation (SA), which provides interoperability and advanced communications capabilities. Generally, IEC61850 is a protocol for multi-device automation and features network communication between controller devices. Such controllers can communicate over a common network 130 such as a TCP/IP based network with other IEC61850-enabled controllers 126, the substations 104, the power plant 102, other assets, equipment, components, apparatuses, microprocessor-based devices such as computers, human-machine interfaces and the like, etc. The controller 128 is legacy controller, which is not IEC61850-enabled. The legacy controller 128 includes existing intelligence for standard protection and/or control functions, and can communicate, via a bus 132, with a master supervisory control and data acquisition (SCADA) control center, which may be located at the corresponding substation 104, via Modbus, DNP, IEC 60870-5, DeviceNet, Profibus, or proprietary protocol, and generally may not be enabled for peer-to-peer based automation functions.

An adapter (A) 134 couples the legacy controller 128 to the network 130. The adapter 134 does not affect the functionality of the legacy controller 128; however, the controller 128 now is also able to communicate with the other assets, such as the other controllers 126, etc. communicating via the network 130. In this respect, the adapter 134 may be considered a local master for the legacy controller 128. As such, the adapter 134 may be configured to obtain appropriate information from the legacy controller 128 and map or convert it to an IEC61850-based data format for transmission over the network 130. In addition, the adapter 134 may be configured map or convert information received in an IEC61850-based data format into a format suitable for the legacy controller 128. The adapter 134 may also include logic for peer-to-peer based automation schemes, if needed. The adapter 134, in effect, makes the legacy controller 128 appear as a IEC61850-compliant controller to the rest of the networked devices.

An adapter configuration tool 136 is configured to communicate over the bus 132 and/or the network 130 with the adapter 134. In one instance, the adapter configuration tool 136 is a PC-based tool, ran an a workstation, desktop computer, laptop, human-machine interface, hand held computer, and the like, used to set-up the adapter 134, including download instructions that can be executed by the adapter 134. The tool 136 is also used to map the outputs of the legacy controller 128 to the IEC61850 protocol. The tool 136 may also be used to create logic functions for the adapter 134. Such functions may be in the form of graphical function-block programming similar to PLC (Programmable Logic Controller) and/or other automation programming. For instance, the tool 136 may allow a user to drag-drop predefined function blocks (combinatorial and sequential logic, timers, comparators, etc.) and connect their I/Os to the legacy controller 128 mapped points, to and/or from the legacy controller 128. The combination controller 128 and the adapter 134 would be perceived by an IEC61850 client as an IEC61850 server described by an SCL file. The SCL file (.ICD) for each server can be combined into a single SCL file describing the entire feeder (as for a substation SCL file). The feeder SCL file would contain the ‘peer-to-peer’ communication according to standard GOOSE syntax.

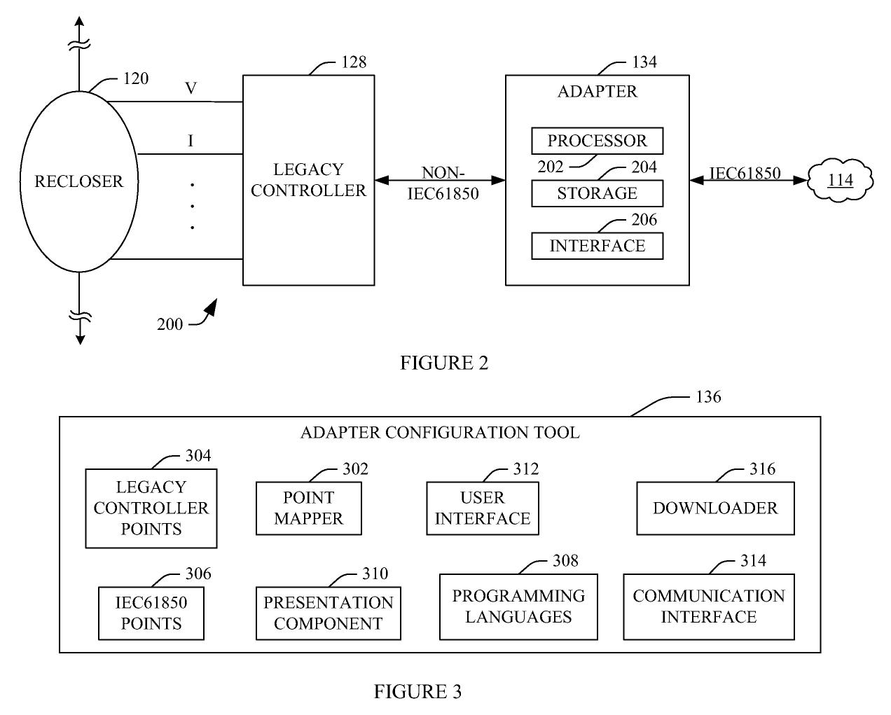

FIG. 2 illustrates an example of the adapter 134 in communication with the legacy controller 128. In this example, the legacy controller 128 communicates via a non-IEC61850 based protocol such as IEC60870-5. The legacy controller 128 includes various I/O 200 for receiving data signals and/or receiving and transmitting control signals. The various I/O 200 may include analog and/or digital channels. In the illustrated example, at least one input channel receives information indicative of a voltage (V) corresponding to an asset(s) protected by the recloser 120. At least another input channel receives information indicative of an electrical current (I) corresponding to an asset(s) protected by the recloser 120. At least another input channel is used to communicate control information between the legacy controller 128 and the adapter 134. Other channels may receive information related to values such as power and/or other data. Still other channels may receive logical inputs, logical outputs, digital inputs, and digital outputs.

The illustrated adapter 134 includes a processor 202 and storage 204, which includes instructions executable by the processor 202, and an interface 206 for connecting to the legacy controller 128 and the network 130. Although shown as a single interface 206, the interface may be separate interfaces, one for communicating with the legacy controller 128 and one for communicating with the network 130. Alternatively, the interface 206 may include a first interface for communicating with the legacy controller 128 and a second interface for communicating with the network 130. The storage 204 also includes memory for storing storage of incoming information, including control and/or data signals, from the network 130 and/or the legacy controller 128.

The adapter 134 is configured to communicate with the legacy controller 128. As such, the adapter 134 is enabled to receive information output by the serial ports of the legacy controller 128. The storage 204 includes instructions for mapping the serial protocol points of the controller 128 to IEC61850 objects, attributes and/or functions, which may include enhanced distribution automation functionality such as digital-to-analog (D/A) logic for fault isolation and restoration. In this respect, the adapter 134 may be considered to include serial-to-IEC61850 functionality. The mapped points can be communicated over the network 130 and hence, the adapter 134 can facilitate communications between the recloser controller 128 and the other assets on the network 130. In this case, the legacy controller 128 is seen as an IEC61850-based device, with the protocol mappings and other adapter functionality transparent to the other devices and/or power system personnel.

FIG. 3 illustrates as example of the adapter configuration tool 136. In this example, the adapter configuration tool 136 includes a mapper 302 that maps the legacy controller points 304 to the IEC61850 points 306, and vice versa. Programming languages 308 includes various languages to generate programs for the adapter 134. Examples of suitable languages include, but are not limited to, C, C++, Java, C#, Python, Pascal, assembly and the like, controller based languages such as FBD (Function block diagram), LD (Ladder diagram), ST (Structured text), IL (Instruction list), SFC (Sequential function chart), etc. As noted above, predefined function blocks can be dragged-dropped and connect the I/O of the legacy controller 128 mapped points.

A presentation component 310 such as a human machine interface includes visual and/or audible indicators for displaying information. A user interface 312 allows a user such as a human user, robot, computer, etc. to interact with the adapter configuration tool 136. The interface may include various displays, lights, buttons, knobs, etc. A communication component 314 provides a communication interface for communication with the adapter configuration tool 136. The adapter configuration tool 136 can also communicate with the adapter 134 via the network 130. A downloader 316 downloads programs to the adapter configuration tool 136. The downloaded programs are executed locally on the adapter 134 and can be replaced, updated, written over, etc. as needed.

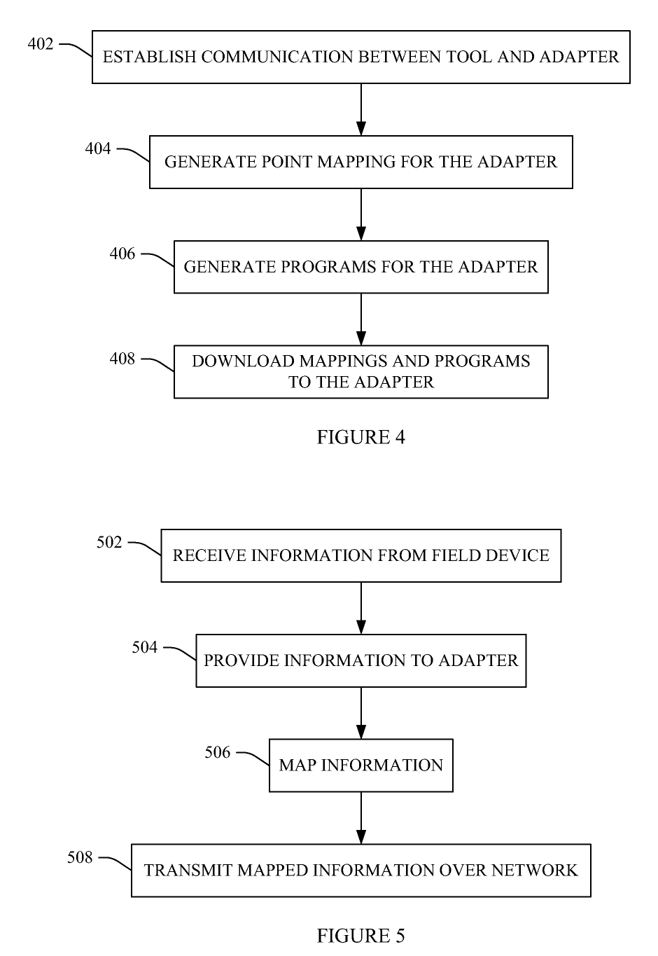

FIG. 4 illustrates a method of programming the adapter 134. At 402, communication is established between the adapter configuration tool 136 and the adapter 134. At 404, the adapter configuration tool 136 is used to generate a mapping between the points of the legacy controller 128 and the adapter 134. Optionally, at 406, the adapter configuration tool 136 is used to generate programs for distribution automation functionality. At 408, the mappings and/or programs are downloaded to the adapter 134, which employs the mappings and executes the programs.

FIG. 5 illustrates a method for mapping legacy controller data points to IEC61850 data points. At 502, the legacy controller 128 receives various information from its corresponding field device. At 504, this information is provided to the adapter 134. At 506, the adapter 134 maps the information to a suitable format, such as an IEC61850-based format, for communication over the network 130. At 508, the adapter 134 communicates the mapped information over the network 130, for example, to another adapter 134, one or the controllers 126, the substation 104, the power plant 102, and/or another asset of the electrical power system.

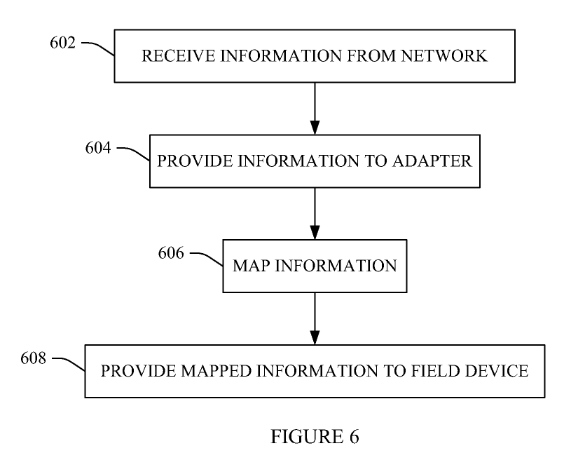

FIG. 6 illustrates a method for mapping IEC61850 data points to legacy controller data points. At 602, the adapter 134 receives various information from the network 130. At 604, this information is provided to the adapter 134. At 606, the adapter 134 maps the information to a suitable format, such as an IEC60870-5 based format, for the legacy controller 128. At 608, the adapter 134 communicates the mapped information to the legacy controller 128, which employs the information to control, monitor, etc. a field device.

In another embodiment, a computer readable storage medium contains instructions which, when executed by a processor, causes the processor to carry out the acts described herein. The processor may be part of a computing device such as a hard controller, a soft controller, a computer, a hand held computing device, etc.

IEC 61850 is the international standard for substation automation systems. It defines the communication between devices in the substation and related system requirements. More specifically, IEC 61850 includes several Ethernet-based communications protocols, together with standardized naming and object modeling. The object model includes physical device (network address of the IED), logical device (logical nodes implemented in the IED), logical node, data and data attribute. A logical node is a named grouping of data and associated services that is logically related to some power system function. The object name structure utilizes logical device, logical node, data and attribute. In addition to the foregoing, IEC 61850 also includes an XML-based Substation Configuration Language (SCL), which was developed to allow for the exchange of configuration data between tools. SCL is used to design, document and exchange both device level and substation level configurations.

Of course, modifications and alterations will occur to others upon reading and understanding the preceding description. It is intended that the invention be construed as including all such modifications and alterations insofar as they come within the scope of the appended claims or the equivalents thereof.

What is claimed is:

1. A controller adapter, comprising:
a controller interface configured to interface with a controller for a legacy field device of an electrical power distribution system, wherein the controller communicates based on a first protocol;
a network interface configured to interface with a network common to a plurality of assets of the electrical power distribution system, wherein the network interface communicates based on a second protocol;
a mapper that maps information, which is received from the controller, about the legacy field device and formatted in accordance with the first protocol, to information formatted in accordance with the second protocol, and that maps information, which is received from the network and formatted in accordance with the second protocol, to information formatted in accordance with the first protocol; and
storage that stores at least one logic function for the legacy field device, wherein at least one input and/or output of the logic function is connected to the mapped information.

2. The controller adapter of claim 1, wherein the logic function is in the form of a graphical function-block.

3. The controller adapter of claim 1, wherein the logic function is in the form of a function block diagram, a ladder diagram, structured text, instruction list, or a sequential function chart.

4. The controller adapter of claim 1, wherein the logic function is in the form of C, C++, Java, C#, Python, Pascal, or assembly language.

5. The controller adapter of claim 1, wherein the first protocol is a non-IEC61850 based protocol and the second protocol is an IEC61850 based protocol.

6. The controller adapter of claim 5, wherein the first protocol is an IEC60870-5 based protocol.

7. The controller adapter of claim 6, wherein the first protocol is a MODBUS based protocol.

8. The controller adapter of claim 6, wherein the first protocol is a DNP based protocol.

9. The controller adapter of claim 6, wherein the network is a TCP/IP based network.

10. The controller adapter of claim 1, wherein the logic function is obtained from an adapter configuration tool.

11. The controller adapter of claim 10, wherein the logic function is generated by an adapter configuration tool.

12. The controller adapter of claim 11, wherein the adapter configuration tool is used to connect the at least one input and/or output of the logic function to the mapped information.

13. The controller adapter of claim 12, wherein the logic function includes one or more of combinatorial logic, sequential logic, a timer, or a comparator.

14. The controller adapter of claim 1, wherein the adapter is perceived on the network as an IEC61850 server.

15. The controller adapter of claim 1, wherein the logic function includes enhanced functionality.

16. A controller adapter configuration tool, comprising:
a mapper that generates a mapping that maps information from a legacy field device controller to an IEC61850-based network; and
a downloader that downloads the mapping to an adapter coupled to the legacy field device controller, wherein the legacy field device controller employs the mapping to map information from the legacy device controller to the IEC61580-based network.

17. The controller adapter configuration tool of claim 16, further including a programming language for creating a logic function for the adapter, wherein the downloader downloads the logic function to the adapter, which executes the logic function.

18. The controller adapter configuration tool of claim 17, further including a mapper that connects at least one input and/or output of the logic function to the mapped information.

19. The controller adapter configuration tool of claim 18, wherein the logic function includes one or more of combinatorial logic, sequential logic, a timer, or a comparator.

20. The controller adapter configuration tool of claim 17, wherein the device controller controls at least one of a circuit breaker, a recloser, a switch, a tie switch, a transformer, a power quality measurement device, or a digital fault recorder.

21. The controller adapter configuration tool of claim 17, wherein the programming language is one a function block diagram, a ladder diagram, structured text, instruction list, or a sequential function chart.

22. The controller adapter configuration tool of claim 17, wherein the programming language is one of a C, C++, Java, C#, Python, Pascal, or assembly language.

23. The controller adapter configuration tool of claim 17, wherein the controller adapter configuration tool is a PC-based tool.

24. A system, comprising:
a legacy controller adapter, including:
a controller interface configured to interface with a controller for a legacy field device of an electrical power distribution system, wherein the controller communicates based on a first protocol;
a first mapper that maps information received from the legacy field device controller about the legacy device that to an IEC61850-based protocol based on a mapping; and
storage that stores at least one logic function, wherein at least one I/O of the logic function is connected to the mapped information; and
a legacy controller adapter configuration tool, including:
a second mapper that generates the mapping; and
a downloader that downloads the mapping to the storage.

25. A method, comprising:
generating a mapping, via an adapter configuration tool, that maps information from a legacy field device controller to an IEC61850-based protocol; and
downloading the mapping to the adapter, wherein the legacy field device controller employs the mapping to map information from the legacy device controller to the IEC61850-based network.

26. A method, comprising: employing a mapping, generated by an adapter configuration tool, to map information from a legacy field device controller to an IEC61850-based protocol and to map information formatted in the IEC61850-based protocol to a protocol of the legacy field device controller, wherein the protocol of the legacy field device is different then the IEC61850-based protocol.
